(19) United States
(12) Patent Application Publication
(10) Pub. No.: US 2023/0000092 A1
(43) Pub. Date: Jan. 5, 2023

(54) Bread for Hamburgers

(71) Applicants: Edgardo Gabriel Lunghi, Buenos Aires (AR); Damián Félix Rodas, Buenos Aires (AR)

(72) Inventors: Edgardo Gabriel Lunghi, Buenos Aires (AR); Damián Félix Rodas, Buenos Aires (AR)

(21) Appl. No.: 17/856,120

(22) Filed: Jul. 1, 2022

(30) Foreign Application Priority Data
Jul. 1, 2021 (AR) 20210101859

(51) Int. Cl. A21D 13/32

(52) U.S. Cl. CPC A21D 13/32

(57) ABSTRACT

Hamburger bun, having two substantially equal halves (1, 2), each of which forms a flat portion (3) mutually facing the other, between which are arranged the foodstuffs (9, 10 11, 12) thus sandwiched, forming opposite to said flat portion (3) a domed shape (4), characterized in that at least one of said halves, in its flat portion (3), has a hollow (5) with a closed bottom (6) that faces toward the domed portion and defines a substantially concentric housing in which the toppings and at least part of the hamburger complements are housed.

### SCOPE OF APPLICATION OF THE PRESENT UTILITY MODEL

The field of application of the present Utility Model is found in the new shape imparted to a hamburger bun, the new shape of which imparts a new result.

### PRIOR ART

Hamburger buns are an obviously well-known resource, and consist of a bun having the appearance of a body of revolution with an elliptical generatrix, which may be selectively cut by its middle horizontal plane, placing between both halves the toppings, the hamburger, and any other desired ingredients such as a slice of tomato, lettuce, a slice of cheese, etc.

However, hot dog buns are also known that have a longitudinal cavity or hole, inside which the Vienna sausage is placed.

Also known are the hot dog buns covered by Ornamental Design No. AR 62092, which illustrate mutually facing hemi-buns, each with a longitudinal depression open at one end and closed at the distal end.

These bun configurations with the aforementioned longitudinal holes or cavities demonstrate that there is a concern over having to accommodate the foodstuff safely inside the bun and keep it from slipping or sliding out when the bun is bitten into, particularly due to the fact that the toppings are oil-based, creating situations in which such food is literally displaced from the bun.

As regards hamburgers, it is also known that the ingredients that accompany the meat foodstuff usually enable its displacement when both halves of the buns are bitten into by the diner. More particularly, it is observed that the components, particularly the tomato slice, together with the toppings such as the mayonnaise or ketchup portion, detach and often end up as stains on the user's clothing.

### OBJECTS OF THE PRESENT UTILITY MODEL

The object of the present invention is a hamburger bun that has at least one housing in one of its halves to hold the toppings and other components of the foodstuff, creating a reservoir for them that prevents their premature exit when the user begins to bite into the pairs of buns facing each other and with the food arranged between the two half-buns.

### SUMMARY OF THE INVENTION

Hamburger bun, having two substantially equal halves, each of which forms a flat portion mutually facing the other, between which are arranged the foodstuffs thus sandwiched, forming opposite to said flat portion a domed shape, characterized in that at least one of said halves, in its flat portion, has a hollow with a closed bottom that faces toward the domed portion and defines a substantially concentric housing in which the toppings and at least part of the hamburger complements are housed.

### BRIEF DESCRIPTION OF THE ATTACHED DRAWINGS

FIGS. 1a and 1b show both halves of the hamburger bun according to the invention;

FIGS. 2a and 2b show both halves of FIG. 1, viewed in a diametric vertical section.

FIGS. 3a and 3b show another configuration of the invention in which the hollows or housings have a different volume, and

FIG. 4 shows a sectional view of a hamburger with the toppings and sides thereof.

### DETAILED DESCRIPTION OF THE PRESENT INVENTION

For purposes of illustrating the preferred embodiments of the present invention, the above-mentioned drawings illustrating the same are attached hereto, supported by the description of the same given below; these embodiments should be interpreted as one of the many possible configurations of the invention, and for this reason should be given no limiting effect, and the possible means equivalent to those illustrated is also included in the scope of the protection of the present invention; the scope of the present invention is determined by the first claim in the corresponding Claims attached hereto.

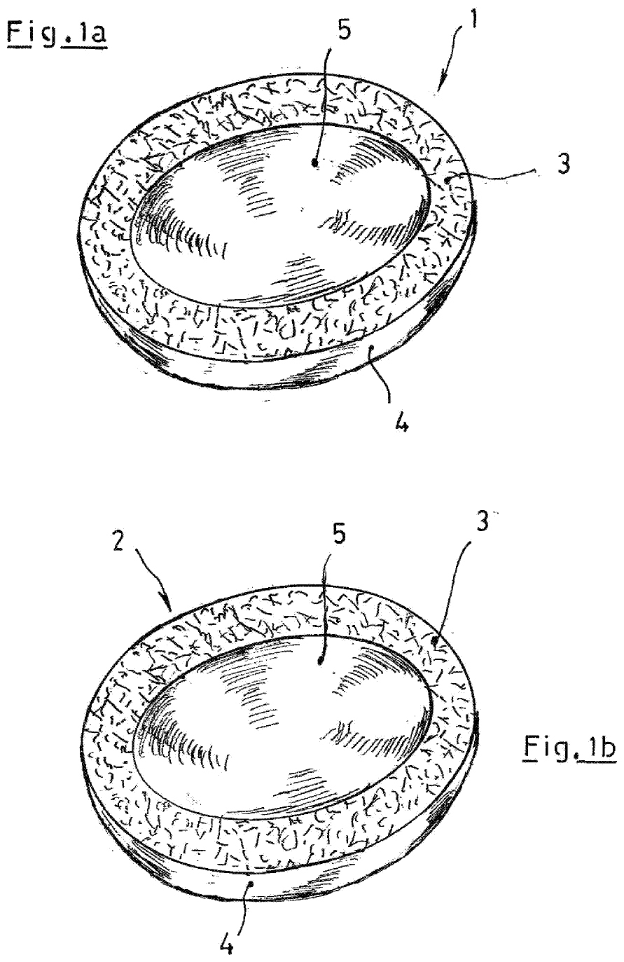

FIG. 1 shows an upper hemi-bun or half-bun (1) and a lower half-bun or hemi-bun (2). These bun halves have a flattened surface (3) turned upwards, so that the opposite domed portion (4) faces downwards. In this configuration of the invention, both halves have a hollow (5) of substantially equal volumes, with an annular edge that forms part of the aforementioned flattened portion (3).

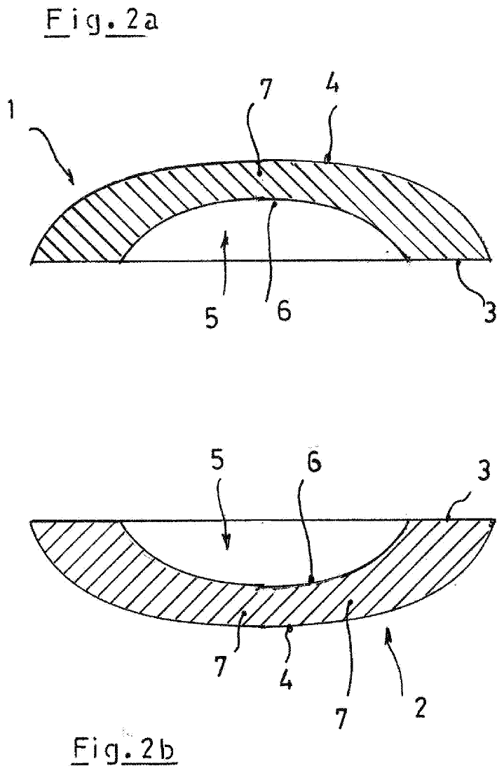

FIG. 2b shows a diametrical section of FIG. 1a, and FIG. 2b shows a diametric section of FIG. 1B. These drawings show hollows (5) of equal volume, with a bottom (6) separated from the dome (4) by a bread wall (7).

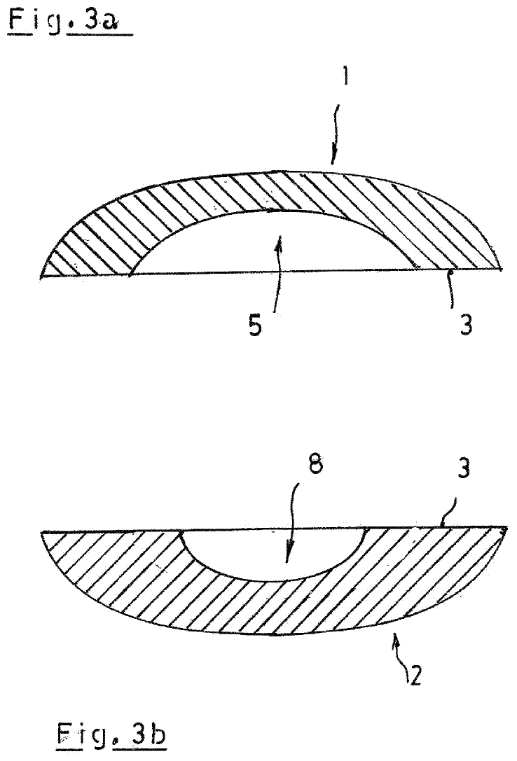

FIG. 3a is the same as the section of FIG. 1a, and in this configuration FIG. 3b has a hemi-bun with a hollow (8) of smaller volume.

It is conceivable according to the invention (in a version not illustrated) that the aforementioned hollow (5) is implemented in only one half of the bun, so that the other bun remains as a traditional hamburger semi-bun.

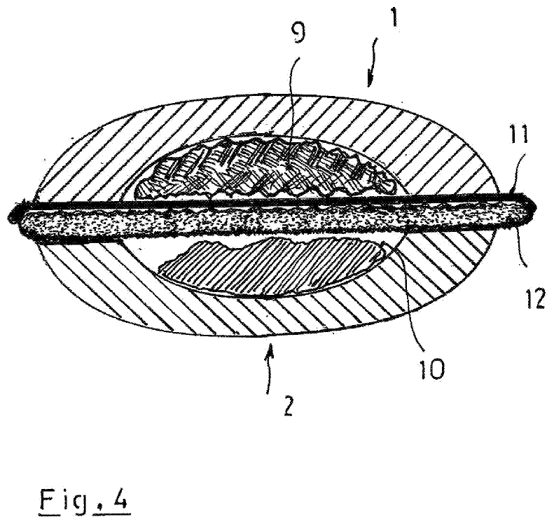

FIG. 4 shows a practical example of how the present invention is used and the result obtained thereby. This drawing schematically illustrates the diametrical section of a hamburger assembled with the buns (1, 2) of the invention. This example represents, without limitation, (9) indicates tomato, onion and/or lettuce slice(s) housed in the upper recess or hollow. In the lower hollow, for example, the topping (10) may be housed, such as a sauce or mayonnaise; (11) is a cheese slice and (12) is the hamburger patty itself. This order can of course be modified. What is really meant to be emphasized is the use and utility of the recesses or hollows (5) that are capable of housing and retaining the components of the hamburger.

The hollows may be achieved by using an elliptical-shaped insert made of a material accepted under bromatological standards during the baking stage, with the additional advantage that if the aforementioned insert reaches a sufficient temperature, it achieves a superficial coating over the hollow or volume that partially waterproofs this recess in the bread dough (7)

1- Hamburger bun, having two substantially equal halves, each of which forms a flat portion mutually facing the other, between which are arranged the foodstuffs thus sandwiched, forming opposite to said flat portion a domed shape, characterized in that at least one of said halves, in its flat portion, has a hollow with a closed bottom that faces toward the domed portion and defines a substantially concentric housing in which the toppings and at least part of the hamburger complements are housed.

2- Hamburger bun, as claimed in claim 1, characterized in that a hollow is present in both halves of the bun.

3- Hamburger bun, as claimed in claims 1 and 2, characterized in that one of the two hollows or recesses is of smaller volume than the other.
